(19) United States
(12) Patent Application Publication
(10) Pub. No.: US 2023/0331329 A1
(43) Pub. Date: Oct. 19, 2023

(54) STABILIZING CAMERA MOUNTS AND METHODS OF USE

(71) Applicant: Ford Global Technologies, LLC, Dearborn, MI (US)

(72) Inventors: Ravin Sardal, Sunnyvale, CA (US); Jim Newton, Redwood City, CA (US)

(73) Assignee: Ford Global Technologies, LLC, Dearborn, MI (US)

(21) Appl. No.: 17/659,826

(22) Filed: Apr. 19, 2022

(51) Int. Cl. B62J 11/00

(52) U.S. Cl. CPC B62J 11/00

(57) ABSTRACT

Stabilizing camera mounts and methods of use are disclosed herein. An example apparatus can include a device mount; a fork mount that couples with a fork of a scooter; an adjustable top plate coupled to the fork mount, the adjustable top plate being configured to change a distance between the camera mount and the fork; a first mount plate disposed under the adjustable top plate; a second mount plate disposed under the adjustable top plate; the camera mount being located under the second mount plate; and a bushing placed between the first mount plate and the second mount plate to reduce vibration of a camera associated with the device mount caused by the fork.

### BACKGROUND

Video footage can be captured by a phone mounted to a scooter to enable the use of vision algorithms. However, because of the out-of-round nature of the tires on many electric scooters and the rough and uneven surfaces on which scooters are typically ridden, the video footage acquired using mounting methods may experience high-frequency vibrations. For example, most phone mounts sold for use with bikes today include a structure that connects the phone directly to the bike, with the main aim being to secure the phone to the handlebars. These connections are rigid and may transfer vibrations to the phone when the scooter experiences vibrations.

### BRIEF DESCRIPTION OF THE DRAWINGS

A detailed description is set forth regarding the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example environment in accordance with one or more embodiments of the disclosure.

FIG. 2 is a perspective view of an example camera mount in accordance with one or more embodiments of the disclosure.

FIG. 3 is a perspective view of the example camera mount in accordance with one or more embodiments of the disclosure.

### DETAILED DESCRIPTION

### Overview

The present disclosure is directed to camera mounts that stabilize a phone when mounted to a scooter. The phone can be mounted to the handlebars of the scooter using an example mount of the present disclosure. One example apparatus is configured to mount a phone on a scooter that would suppress/reduce, and reduce/eliminate vibrations transferred to the phone to enable stable clean video footage to be produced. The apparatus suspends and isolates the phone from vibrations produced by the frame of the scooter. In one example, a viscoelastic material, such as a polyurethane foam, or low-resilience polyurethane foam can be incorporated into the camera mount used to provide isolation. The apparatus can easily be mounted on the scooter to be used when required, and equally easily removed.

### Illustrative Embodiments

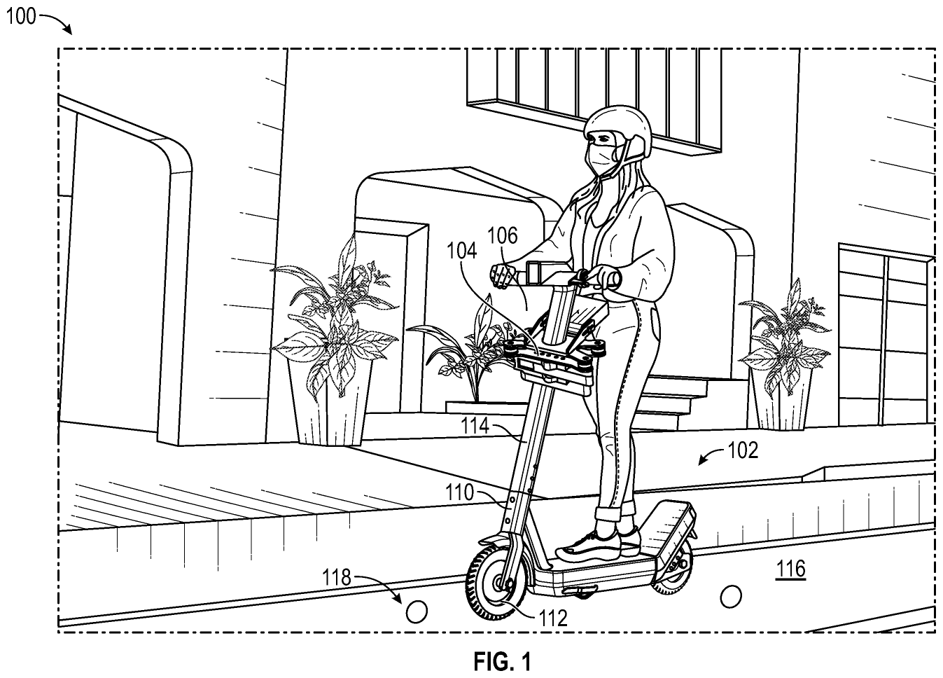

Turning now to the drawings, FIG. 1 depicts an illustrative architecture 100 in which techniques and structures of the present disclosure may be implemented. The architecture 100 includes a scooter 102, a camera mount 104, and a mobile device 106. While the scooter 102 has been described and illustrated, the salient aspects of the present disclosure can be applied to any transportation or transportation-related apparatus such as a bicycle, a bicycle helmet, a motorcycle, and so forth. Generally, the camera mounts disclosed herein can be used to couple a camera to a fixed element that may be subject to vibrations that would be transferred to the mobile device 106. Also, while examples herein disclose the mobile device 106 as a Smartphone or cell phone, the mobile device 106 can include any portable computing device with a camera.

Some users may employ their mobile device for purposes such as navigation or vision-based features such as augmented reality or virtual reality. A camera or cameras of the mobile device can be used to capture images. These images can be processed using various algorithms for various purposes as noted above. The user may desire to attach the mobile device 106 directly to the scooter 102, rather than holding the mobile device 106 by hand. The mobile device can be mounted to any part of the scooter, but for an optimized field of view for the camera of the mobile device 106, the mobile device 106 can be mounted to the handlebars of the scooter 102. The scooter 102 can comprise a frame 110 with wheels 112. The fork 114 can be associated with the frame 110. The user may wish to couple the mobile device 106 to the handlebar 114 to allow the mobile device 106 to capture images through one or more camera(s).

For example, the scooter 102 may be operated on a rough operating surface 116 that includes irregularities 118 such as potholes, rocks, uneven pavement, or other imperfections. As the scooter 102 travels over the rough operating surface 116, vibrational forces caused by irregularities 118 may be transferred through the wheels 112 and into the frame 110, and the fork 114. The fork 114 couples to the handlebars of the scooter 102. Ideally, the mobile device 106 can be coupled to the fork 114 because it remains forward-facing, whereas the handlebars rotate when turned by the user of the scooter. When the mobile device 106 is coupled directly to the fork 114, these vibrational forces are transferred to the mobile device 106, which may reduce the quality of the images obtained by the mobile device 106.

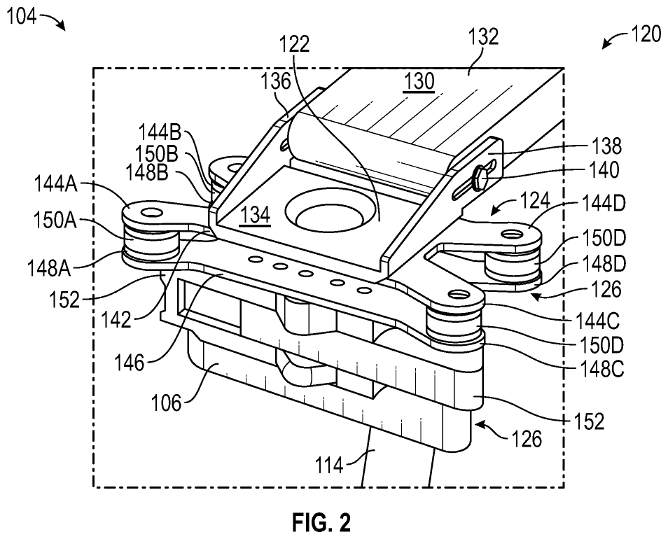

In order to reduce and/or eliminate these deleterious effects, the camera mount 104 may be joined to the fork 114. The user places the mobile device 106 in the camera mount 104 to securely mount the mobile device 106. Referring now to FIG. 2, which illustrates the camera mount 104 in greater detail. The camera mount 104 can comprise a fork mount 120, an adjustable top plate 122, a first mount plate 124, a second mount plate 126, and a device mount 128. The mobile device 106 can be secured in the device mount 128.

The camera mount 104 can be coupled to the scooter 102 by use of the fork mount 120. The fork mount 120 can include a body 130 and mounting ring 132. The mounting ring 132 encircles the fork 114 and can be clamped down to tighten the camera mount 104 to the fork 114. In some instances, the portion of the mounting ring 132 that contacts the fork 114 can be a viscoelastic material to absorb handlebar vibration.

The adjustable top plate 122 includes a body 134 with opposing track armatures 136 and 138. In general, the adjustable top plate 122 provides a means to adjust/move the mobile device 106 away from the fork of the scooter 102.

Alternatively, a top plate may be designed to only accommodate a specific phone make and model. Utilizing the known dimensions of a specific phone to ensure that when placed in the phone mount, the phone is distanced from the fork of the scooter.

The adjustable top plate 122 may be used to selectively adjust a distance of the mobile device 106 relative to the fork 114, when the mobile device 106 is coupled to the camera mount 104. That is, fasteners, such as a fastener 140 can interface with the track armature 138. In more detail, each side of the body 130 of the fork mount 120 can have threaded shafts that slide within grooves of the track armatures. Fasteners can be threaded onto the ends of the threaded shafts.

When the fastener 140 is loosened, the adjustable top plate 122 and elements below the adjustable top plate 122 can slide forwards and backwards. When the desired position or location has been achieved, the user can tighten the fastener 140 to lock the adjustable top plate 122 in place (a similar operation is performed for another fastener on the opposite side, which is not shown). The adjustment ensures that when placed in the mount, the mobile device 106 does not collide with the fork 114 of the scooter 102. The adjustable top plate 122 may include markings or indicia to identify predetermined locations that can be utilized to for specific device manufacturers and models. For example, due to size variations, some phones may be placed at different distances away from the fork 114 relative to other phones.

The first mount plate 124 can be mounted to an underside of the adjustable top plate 122. In general, the first mount plate 124 is associated with the fork mount through the adjustable top plate 122. The first mount plate 124 can comprise a body 142 with tabs 144A-144D. While four tabs are shown, fewer or more tabs can be used. The second mount plate 126 is located below and in spaced-apart relationship with the first mount plate 124. The second mount plate 126 can also comprise can comprise a body 146 with tabs 148A-148D. In some instances, the tabs 144A-144D of the first mount plate 124 and the tabs 148A-148D of the second mount plate 126 are aligned. The camera mount 104 can comprise bushings 150A-150D placed between the tabs of the first and second mount plates. For example, the bushing 150A is placed between the tab 144A of the first mount plate 126 and the tab 148A of the second mount plate 126. Thus, a bushing can be placed between each of the pairs of tabs of the first and second mount plates. These bushings can be created from a viscoelastic material that absorbs vibrational forces. Thus, vibrational forces that would ordinarily be transferred from the scooter to the camera mount 104 may be damped by the bushings. Thus, while some vibration may be transferred to the fork mount 120, the adjustable top plate 122, or the first mount plate 124, such forces may be damped and prevented from propagating to the second mount plate 126 by the bushings. As noted above, the bushings can be created from a polyurethane foam, or low-resilience polyurethane foam. It will be understood that the height and/or diameter of the bushings can vary to allow for corresponding variances in damping effects.

In some configurations, the first mount plate 124 and the second mount plate 126 can each be manufactured from a plastic, a polymeric material, or a viscoelastic material. In combination, the first mount plate 124, the second mount plate 126, and the bushings 150A-150D can cooperatively damp vibrations that would otherwise be transferred to the mobile device 106.

The device mount 128 can comprise any mechanism that is configured to receive and secure the mobile device 106. For example, the device mount 128 could include a clamp or clasp created from two opposing plates 152 and 154. The mobile device 106 can be captured between these two plates. In some instances, the plates can be selectively moved towards/away from one another to receive and retail mobile devices of differing thicknesses or dimensions. The plates 152 and 154 can translate laterally relative to one another to expand and contract. The plates 152 and 154 can be resiliently biased with a spring or other similar mechanism. The plates can be spread apart and the mobile device 106 can be placed between the plates. When the user releases the plates, the resilient biasing brings the plates towards one another capturing the mobile device 106 therebetween. In some instances, the device mount 128 may not be a separate component, but can be integrated underneath the second mount plate 126.

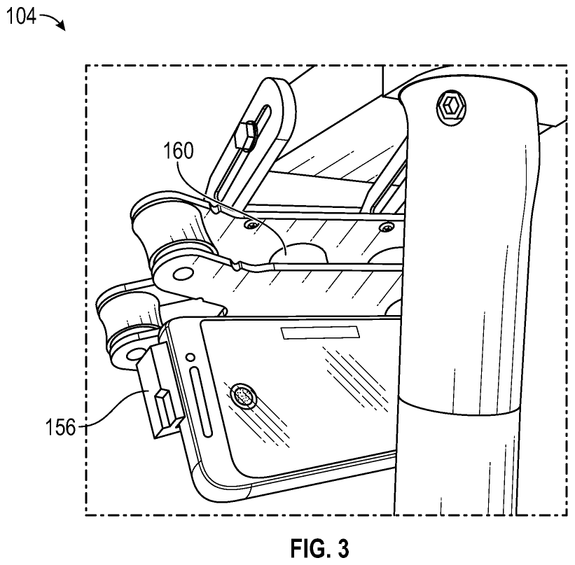

Referring now to FIGS. 2 and 3 collectively, each of the plates 152 and 154 includes a brace, such as the brace 156 associated with plate 152. These braces contact sides or edges of the mobile device 106 to lock the mobile device 106 is place. In addition to the bushings described above, the camera mount 104 can also comprise a central damper 160 that is placed between the first mount plate 124 and the second mount plate 126. The central damper 160 can be centrally located in some instances. As with the bushings, the central damper 160 can be constructed from a viscoelastic material. In some instances, the central damper 160 can replace the bushings disclosed above. It will be understood that the central damper 160 and the bushings 150A-150D can be referred to as a vibrational damper.

Although the subject matter has been described in language specific to structural features and/or methodological acts, it is to be understood that the subject matter defined in the appended claims may not necessarily be limited to the described features or acts described above. Rather, the described features and acts are disclosed as example forms of implementing the claims.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “mechanically connected,” etc., are used interchangeably herein to generally refer to the condition of being mechanically/physically connected. The terms “couple” and “coupling” are also used in a non-mechanical/physical context that refers to absorption of microwave energy by a material. It is further noted that various figures (including component diagrams) shown and discussed herein are for illustrative purpose only, and are not drawn to scale. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing and/or other any other types of manufacturing. For example, some manufacturing processes include three-dimensional (3D) printing, laser cutting, computer numerical control (CNC) routing, milling, pressing, stamping, vacuum forming, hydroforming, injection molding, lithography and/or others.

Any and/or all elements, as disclosed herein, can include, whether partially and/or fully, a solid, including a metal, a mineral, a ceramic, an amorphous solid, such as glass, a glass ceramic, an organic solid, such as wood and/or a polymer, such as rubber, a composite material, a semiconductor, a nano-material, a biomaterial and/or any combinations thereof. Any and/or all elements, as disclosed herein, can include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, non-transparency, luminescence, anti-reflection and/or holographic, a photo-sensitive coating, an electronic and/or thermal property coating, such as for passivity, insulation, resistance or conduction, a magnetic coating, a water-resistant and/or waterproof coating, a scent coating and/or any combinations thereof.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. An apparatus comprising:
a device mount;
a fork mount that couples with a fork of a scooter;
an adjustable top plate coupled to the fork mount, the adjustable top plate being configured to change a distance between the device mount and the fork;
a first mount plate disposed under the adjustable top plate;
a second mount plate disposed under the first mount plate;
the device mount being located under the second mount plate; and
a bushing placed between the first mount plate and the second mount plate to reduce vibration of a camera associated with the device mount caused by the fork.

2. The apparatus according to claim 1, the adjustable top plate comprises a body and two track armatures located on either side of the body, the device mount being coupled to the two track armatures.

3. The apparatus according to claim 2, wherein the body of the adjustable top plate is fixed in position using a fastener associated with one of the two track armatures.

4. The apparatus according to claim 1, wherein the first mount plate comprises a first mount plate body having a first set of tabs extending from the first mount plate body and the second mount plate comprises a second mount plate body having a second set of tabs extending from the second mount plate body, wherein when the first mount plate body and the second mount plate body are aligned, the first set of tabs align with the second set of tabs.

5. The apparatus according to claim 4, further comprising a tab bushing disposed between each pair of the first set of tabs and the second set of tabs.

6. The apparatus according to claim 5, further comprising a central bushing disposed between the first mount plate body and the second mount plate body.

7. The apparatus according to claim 1, wherein the device mount comprises a first plate and a second plate that clamp the camera into place.

8. The apparatus according to claim 7, wherein the first plate and the second plate each comprise a bracket that engages with the camera.

9. An apparatus comprising:
a fork mount that couples with a fork of a scooter;
a first mount plate associated with the fork mount;
a second mount plate disposed under the first mount plate;
a device mount that receives a mobile device, the device mount being located under the second mount plate; and
a viscoelastic member placed between the first mount plate and the second mount plate to reduce vibration of the mobile device.

10. The apparatus according to claim 9, further comprising an adjustable top plate that comprises a body and two track armatures located on either side of the body, the device mount being coupled to the two track armatures.

11. The apparatus according to claim 10, wherein the body of the adjustable top plate is fixed in position using a fastener associated with one of the two track armatures.

12. The apparatus according to claim 9, wherein the first mount plate comprises a first mount plate body having a first set of tabs extending from the first mount plate body and the second mount plate comprises a second mount plate body having a second set of tabs extending from the second mount plate body, wherein when the first mount plate body and the second mount plate body are aligned, the first set of tabs align with the second set of tabs.

13. The apparatus according to claim 12, further comprising a tab bushing disposed between each pair of the first set of tabs and the second set of tabs.

14. The apparatus according to claim 13, further comprising a central bushing disposed between the first mount plate body and the second mount plate body.

15. The apparatus according to claim 14, wherein the tab bushing disposed between each pair of the first set of tabs and the second set of tabs and the central bushing are a viscoelastic material.

16. The apparatus according to claim 9, wherein the device mount comprises a first plate and a second plate that clamp the mobile device into place.

17. The apparatus according to claim 16, wherein the first plate and the second plate each comprise a bracket that engages with the mobile device.

18. An apparatus comprising:
a fork mount that couples with a fork of a scooter;
a first mount plate associated with the fork mount;
a second mount plate disposed under the first mount plate; and
a vibrational damper between the first mount plate and the second mount plate, the vibrational damper preventing vibration transmitted through the fork and into the fork and the first mount plate from being transferred to the second mount plate.

19. The apparatus according to claim 18, further comprising a device mount coupled with the second mount plate.

20. The apparatus according to claim 18, wherein the vibrational damper comprises a central bushing disposed between the first mount plate and the second mount plate.
